(19) United States
(12) Patent Application Publication
(10) Pub. No.: US 2013/0335814 A1
(43) Pub. Date: Dec. 19, 2013

(54) Method and apparatus for control of excess pump power in optical amplifiers

(71) Applicant: Martin Ole Berendt, Arvore (PT)

(72) Inventor: Martin Ole Berendt, Arvore (PT)

(21) Appl. No.: 13/517,622

(22) Filed: Jun. 14, 2012

(51) Int. Cl. H01S 3/067

(52) U.S. Cl. CPC H01S 3/06754
USPC 359/341.3

(57) ABSTRACT

A method for control of excess pump power in an optical amplifiers is disclosed. In one particular exemplary embodiment the method comprises a state model for the amplifier gain medium ground energy level inversion and a closed loop control tracking a desired degree of excess pump power.

### FIELD OF THE INVENTION

The present invention relates generally to controlling optical amplifiers, and more particularly to controlling optical pump power in amplifiers with core or cladding guided optical pump, subject to temporal varying amplifier input power.

Optical amplifiers find applications in amplification of optical communication signals and as power amplifiers for power scaling of laser outputs. The control method and apparatus of the invention is particularly valuable in optical amplifiers operating near the linear gain regime where distortion of pulses and bursts of pulses is low. In this regime some excess pump power is needed to maintain the amplifier in the operating regime. The invention provides a means for optimizing the amount of excess pump power.

### BACKGROUND OF THE INVENTION

Rare earth laser medium like Er or Yb doped silica is characterized by long (˜ms) lifetime of the laser energy level. When the ions are excited to the laser energy level they will not absorb optical pump launched into the laser medium. The deexcitation of the laser energy level depends on the input signal power. At low or zero input power the only deexcitation mechanism is spontaneous emission and its amplification know as amplified spontaneous emission (ASE). In the situation where pumps are on and the input signal is low the inversion is high and as a consequence the pump is not absorbed. The pump light is transmitter with low absorption, it leaks through. This leaking pump power is dumped and dissipated in optical elements like Faraday optical isolators or a dedicated pump dump element. In cladding pumped high power fiber amplifiers tens of watt pump power may be used to boost the signal. The pump dump is typically formed by a replacement of the low refractive index secondary cladding also referred to as coating with a polymer resin having a refractive index higher than that of the cladding glass. With current pump dump techniques the pump power, which can safely be absorbed sets a limit to how large a fraction of the total launched pump power can be allowed to leak through without damage to the pump dump or excessive heating of other system parts.

Resent high power fiber lasers, for example often use a high power booster amplifier on the output. These are low gain but high saturated output power amplifiers designed with low pump absorption coefficient and high coupled optical pump power to show low degree of saturation, even with strong input signal powers. When operation with a strong input signal the pump power is converted to useful signal power exiting the amplifier. If the signal input power drops the pump power will be dissipated in the pump dump. Developments in pump laser diodes and coupling devices have allowed a rapid increase in the pump power available in optical amplifiers. This is being exploited in amplifiers with higher power ratings. Because of this the existing pump dump designs and pump power control systems are reaching their limits. The invention addresses the mentioned shortcomings of current amplifier systems and presents an optimal pump power control method.

The currently used techniques used to overcome the problem includes strengthening of the pump dump device to handle higher dissipated power levels, e.g. by material choice or by distributing pump dumping over a larger volume, and use of liquid coolant.

Direct measurement of the leaking pump power for closed loop control feedback is a possible approach, but it is getting more difficult with the increasing pump powers. The reason for this is that measurement of the pump power involves tapping off a small fraction of the high power pump for detection. Since the high pump power is contained in many and varying spatial modes tapping off a constant fraction of the power is technically challenging. An integrating detector like e.g. thermal detection will provide a slow detection.

Some optical fiber amplifier designs resort to the use of an excessively long, longer than needed for the design gain, doped fiber, such that it will never bleach completely. This has the limitation of increased cost and it gives a low threshold for optical nonlinearities in addition to departure from linear gain operation.

Optical nonlinearities for the signal to be amplified scale with the length of the gain fiber, such that a shorter fiber show less nonlinear effects. A long amplifier fiber with low pump leakage will show gain saturation, signal pulses of long duration will be distorted with a leading peak from high initial gain, followed by a less amplified tail. To overcome this the optical amplifier must be designed with short gain section length and strong pump to operate in the linear, non saturated regime. In such amplifier the leaking pump becomes a critical parameter and control like the one disclosed herein is highly valuable.

### SUMMARY OF THE INVENTION

It is the objective of the invention to provide a pump control apparatus which limits the pump power injected into an amplifier whenever the ground level inversion is low and there are only few ions in the energy state from which they can absorb pump power. The method of the invention achieves this by means of an equivalent circuit state model for the ground level inversion. The apparatus comprises a means of receiving input power information, a state model for the ground level inversion, measurement of a parameter in the state model which is representative of the pump absorption, decision circuit comparing the pump absorption estimate with a setpoint, a pump power control connected to the decision circuit.

The theoretical justification for an equivalent electric circuit model of the amplifier is based on the rate equations see e.g. Erbium-Doped Fiber Amplifiers: Principles and Applications, Emmanuel Desurvire, John Wiley & Sons, Inc. 1994 p. 6. For the purpose of gain dynamics simulations the equations are simplified in the paper; Doped-Fiber Amplifiers Dynamics: A System Perspective Alberto Bononi and Leslie A. Rusch, Journal of Lightwave Technologies Vol. 16 No. 5 May 1998, pp. 945-956. Abstract voltage controlled current sources are used in the paper, these can be defined in simulation software. As described below the theory can be cast into a form appropriate for leaking pump estimation and for the actual construction of a state model. In the disclosed invention the current sources are approximated with real hardware circuit elements; transistors, diodes, resistors, capacitors and inductors.

In addition to protecting the pump dump from catastrophically optical damage the control apparatus give several other benefits. First, it improves the systems' energy efficiency by increasing average pump utilization, second it limits the inversion which can prevent spurious lasing in the absence of an amplifier input signal, and third it suppresses the first pulse in gated pulse train amplification which without the control apparatus could experience a high gain and overshoot.

### BRIEF DESCRIPTION OF THE DRAWINGS

For a more complete understanding of the present invention, and advantages thereof, reference is now made to the ensuing descriptions taken in connection with the accompanying drawings briefly described as follows:

FIG. 1 Simplified laser medium energy level diagram.

FIG. 2 Amplifier structure

FIG. 3 Amplifier construction to which the invention applies.

FIG. 4 Pump transmission dynamics model.

FIG. 5 The pump control apparatus of the invention.

FIG. 6 Pump control process flow chart.

FIG. 7 Dynamic model core implementation with circuit elements.

FIG. 8 Optical amplifier controller inputs and outputs.

FIG. 9 Exemplary circuit embodiment of the disclosed control

FIG. 10 Optical pump drive connected to the control circuit

FIG. 11 Graph showing four trances, Vset (d) and V (c) are near equal at 4.5V as the pump (a) is adjusted by the control in response to the signal square pulse (b).

FIG. 12 Graph with expanded scale showing two traces, the signal square pulse (f) of 15 ms high and 15 ms low and the pump (e). The control brings the pump level up when the signal is high.

FIG. 13 Graph showing the voltage drop across the pump laser diode. The drop in voltage is caused by the forward current which is producing the optical pump power output.

### DESCRIPTION OF THE INVENTION

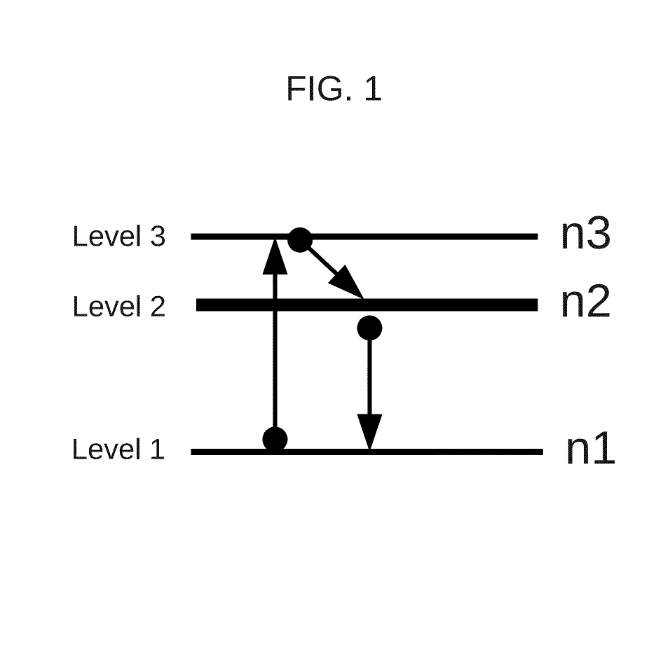

Referring to FIG. 1, level 1 is the ground level, level 2 is the metastable laser level characterized by a long lifetime (τ) and level 3 is the upper pump level. The laser transition of interest for amplification takes place from level 2 to level 1. Pump is absorbed by excitation of the transition from level 1 to level 3. For a useful laser system, like e.g. Erbium-Doped silica the transition from level 3 to level 2 is fast. The gain dynamics is therefor governed by the population in the ground level or pump band (level 1) named n1 and the population in the excited state (level 2) named n2. With no optical input all ions are in the ground level, if pump is applied it will experience maximum absorption since all ions are available for the level 1 to level 3 transition. Due to the long lifetime of level 2 excited ions will accumulate there, and the gain medium turns transparent to the pump.

The purpose of the invention is to limit the pump power before the gain medium turns transparent to the pump radiation.

The invention is a control apparatus which regulates pump power applied to the gain medium in an optical amplifier based on an electronics circuit with a dynamics adjusted to track the pump absorption in the gain medium when the amplifier signal input power varies over time.

The basis for the control is the laser rate equations. Following the formalism from Doped-Fiber Amplifiers Dynamics: A System Perspective Alberto, Bononi and Leslie A. Rusch, Journal of Lightwave Technologies Vol. 16 No. 5 May 1998, pp. 945-956, but here solving for N₁ instead of for N₂, since the pump absorption transition is from energy level 1 to level 3, see FIG. 1.

The rate equation for the fraction of ions (N₁=n1/ρAL) in the ground state, energy level 1.

$$\frac{\partial {N}_{1} ( z , t )}{\partial t} = \frac{( 1 - {N}_{1} )}{τ } + \frac{1}{ρ A} [ \frac{\partial {Q}_{P}}{\partial z} + \frac{\partial {Q}_{s}}{\partial z} ] \qquad ( 1 )$$

ρ: active ion concentration.
L: Gain medium length, the space variable z varies from 0 (input) to L (output).
A: Gain medium cross section area.
τ: Spontaneous decay lifetime.
t: is the time.
Q_{P} and Qₛ are the pump and signal photon fluxes respectively, here the case of forward pumping only is shown, generalization to more signals and pump directions is straight forward to anyone with ordinary skills in laser physics.

Equation (1) quantifies the temporal variation in the ground level population. The left-hand side show that N₁ has positive contribution from spontaneous decay, is reduced by pumping since Op is decreasing in the forward direction and has a positive contribution from signal stimulated emission, Qₛ is increasing towards in output of the amplifier. The propagation of the photon fluxes are described by:

$$\begin{matrix}\frac{\partial {Q}_{P} ( z , t )}{\partial z} = ρ {Γ}_{P} [ {σ}_{P}^{e} - {N}_{1} {σ}_{P}^{T} ] {Q}_{P} & ( 2 ) \\ \frac{\partial {Q}_{s} ( z , t )}{\partial z} = ρ {Γ}_{s} [ {σ}_{s}^{e} - {N}_{1} {σ}_{s}^{T} ] {Q}_{s} & ( 3 )\end{matrix}$$

Γ: is the pump and signal field confinement factors.
σ: denotes emission and absorption cross sections.

Integrating the spatial variation in equation (2) yields:

$$ln ( \frac{{Q}_{P} ( L , t )}{{Q}_{P} ( 0 , t )} ) = ρ {Γ}_{P} {σ}_{P}^{e} L - ρ {Γ}_{P} {σ}_{P}^{T} {\int }_{0}^{L} {N}_{1} ( z , t ) d z \qquad ( 4 )$$

The pump transmission is identified as exactly the left hand side of equation (4) since the pump flux at the output, z=L dived by that at the input, z=0 is the transmission coefficient (T). Recalling

$$T = \frac{{Q}_{P} ( L , t )}{{Q}_{P} ( 0 , t )} , \\ A = \frac{( {Q}_{P} ( 0 , t ) - {Q}_{P} ( L , t ) )}{{Q}_{P} ( 0 , t )} = 1 - T \qquad ( 5 )$$

it is equivalent to discuss transmission T and absorption A.

The pump transmission coefficient takes its minimum when N₁=1, all ions in the ground level:

$$\begin{matrix}\frac{{Q}_{P} ( L , t )}{{Q}_{P} ( 0 , t )} = exp ( ρ {Γ}_{P} {σ}_{P}^{e} L - ρ {Γ}_{P} {σ}_{P}^{T} L ) \\ = exp ( - ρ {Γ}_{P} {σ}_{P}^{a} L )\end{matrix} \qquad ( 6 )$$

and has a maximum when N₁=0, all ions in excited states and not absorbing pump radiation:

$$\frac{{Q}_{P} ( L , t )}{{Q}_{P} ( 0 , t )} = exp ( ρ {Γ}_{P} {σ}_{P}^{a} L ) \qquad ( 7 )$$

which in fact show a pump gain since the pump output is large than the input. This situation of pump gain may not be attainable for pumping at one wavelength, but it is important for the safe operation of the amplifier that such situation is not approached by uncontrolled application of pump power.

The temporal variation of the pump absorption depends only on the average ground state inversion, integral of N₁. This leads to the definition of the one point state variable s(t):

s(t)=ρpA∫₀^{L}N₁(z,t)dz (8)

Using the variable s and integrating with respect to z, equation (1) reads:

$$\frac{d s ( t )}{d t} = \frac{L ρ A - s ( t )}{τ} + [ {Q}_{P} ( L , t ) - {Q}_{P} ( 0 , t ) ] + [ {Q}_{s} ( L , t ) - {Q}_{s} ( 0 , t ) ] \qquad ( 9 )$$

The pump transmission is determined by s(t) through equation (4) and s(t) can be found by solving equation (9) under given boundary conditions. A numerical solution is possible but the aim is to generate a real time control signal to avoid applying pump if the absorption is below some preset acceptance level and the dynamics can be fast compared to the spontaneous lifetime on to order of milliseconds. The invention uses an electronics circuit with an electrical net to ground voltage which tracks s(t).

Equation 9 can be represented as a capacitor charge and discharge dynamics. Substituting V(t) for s(t) and net currents for pump and signal photon fluxes the equivalence becomes more evident.

$$\frac{d V ( t )}{d t} = \frac{L ρ A - V ( t )}{τ} + {I}_{P}^{Netto} + {I}_{s}^{Netto} \qquad ( 10 )$$

The three right hand side terms are the contribution to N₁ from spontaneous decay (LρA-V)/τ this can be implemented by charging through a resistor, the second term is the reduction of N₁ by the pump and the last term is the addition to N₁ by signal stimulated emission of transition from a higher energy level to the ground level. This is the basis for the equivalent circuit model for ground state inversion.

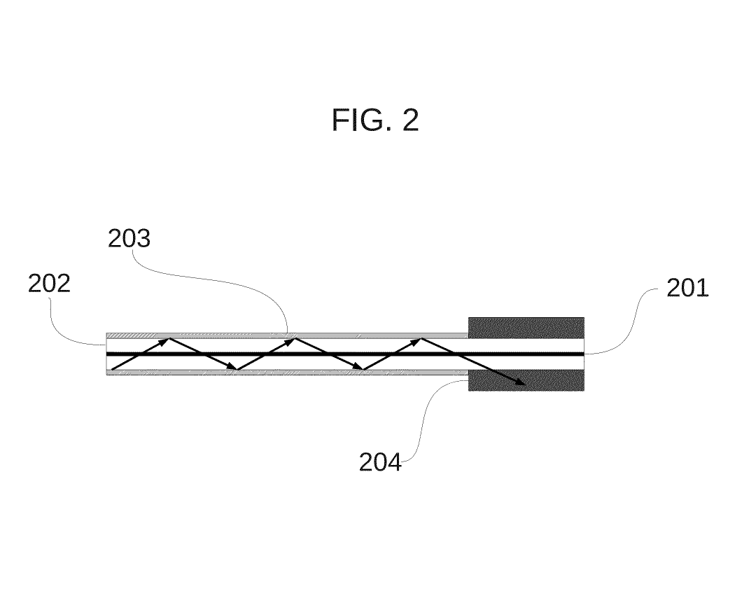

The invention relates to amplifiers in which the pump radiation is guided by a waveguide surrounding the gain medium with active ions. FIG. 2 shows such an arrangement. The pump light is guided by a waveguide having a pump core 202 and pump cladding 203 of a material with a refractive index lower that that of the pump core. The signal to be amplified is traveling in the signal core 201. The pump light zigzag inside the pump core undergoing total internal reflections at the pump core to cladding interface. At the interruption of the pump guide the pump leaks out in the pump dump 204.

The pump dump may be formed by replacing the low index cladding with a high index material, often a polymer. When only a small fraction of the applied pump radiation reaches the pump dump the power handling requirement is easily met. If the gain medium is bleached by strong pumping in the absence of corresponding amplifier input signal a large fraction of the pump power reaches the pump dump and excessive heating or catastrophic damage can result. With pump bleaching it is meant that ground state population is low and transmission is high, i.e. absorption is low.

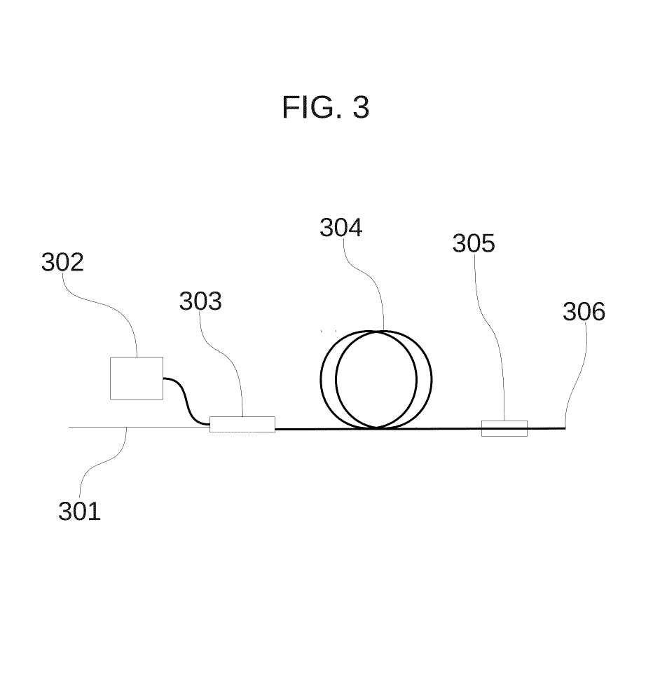

A typical example of a guided pump optical amplifier is the cladding pumped rare earth doped optical fiber amplifier. As illustrated in FIG. 3 such amplifier has a signal input 301, a pump source 302 typically a laser diode, an optical element combining the signal and pump in the gain fiber 304, a pump dump 305 to separate the pump radiation from the useful amplified signal exciting from the amplifier output 306.

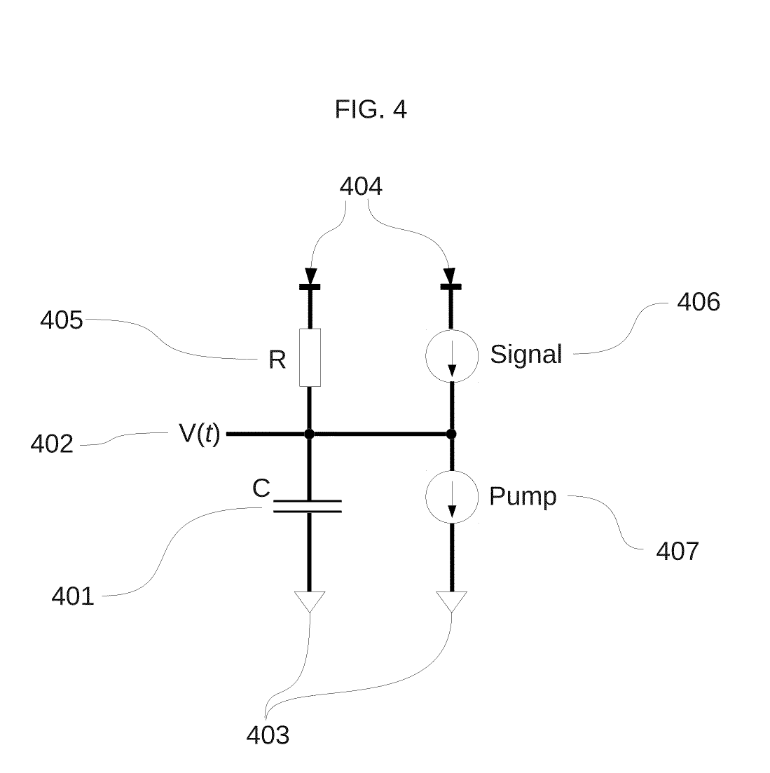

FIG. 4 shows a simplified electronics circuit diagram which has a dynamics in accordance with equation 10. The electronics circuit follow variations in pump transmission in an optically pumped optical amplifier. The voltage V(t) 402 across the capacitor 401 represents the fraction of ions in the ground energy level. The smaller the voltage V(t) the larger the pump transmission, low absorption and larger leaking pump power hitting the pump dump. Pumping is represented by the current source 407 from V(t) to the lower supply rail 403 reduces the voltage. Signal represented by the current source 406 from the upper supply rail to V(t) increase the voltage. Spontaneous decay from a higher energy level to the ground level, represented by charging resistor (R) 405 from the upper supply rail to V(t) also contribute to increase in voltage. V(t) gives real time information as to what pump absorption is expected and is in the invention used for control of the optical pump power applied to the optical amplifier.

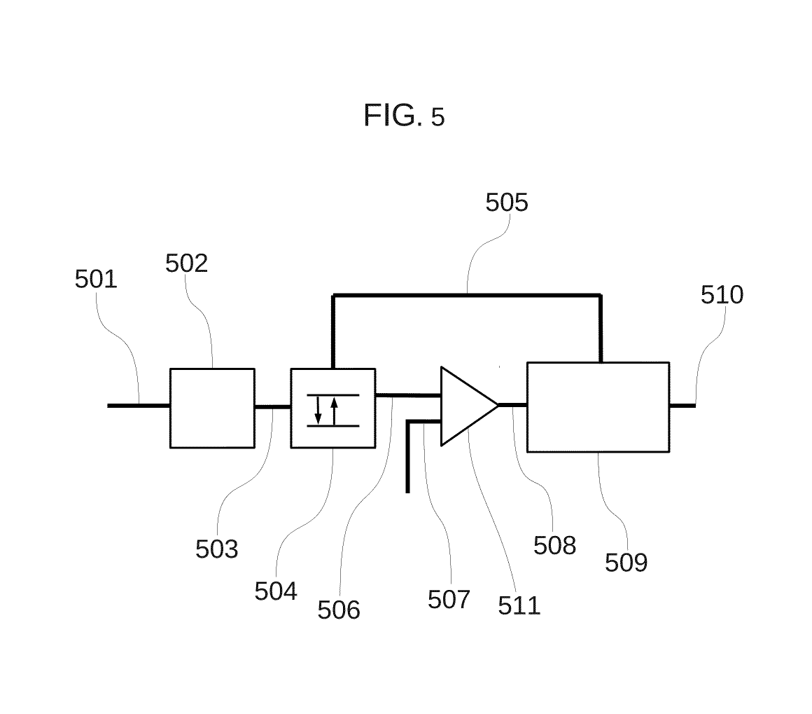

The controller of the present invention is schematically represented in FIG. 5. The controller comprises a means 501 of receiving input power information and condition it 502, a dynamic model for ground state inversion 504 which receives input power information via a connection 503 and pump rate information via 505, measurement of a parameter in the state model which is representative of the pump absorption reported via 506 to a decision circuit 511 comparing the pump absorption with a setpoint value set on 507, to produce an error or deviation signal for feedback control. A pump power control 509 is connected to the decision circuit and a servo signal 510 control, adjust or regulate pump power applied to the optical amplifier.

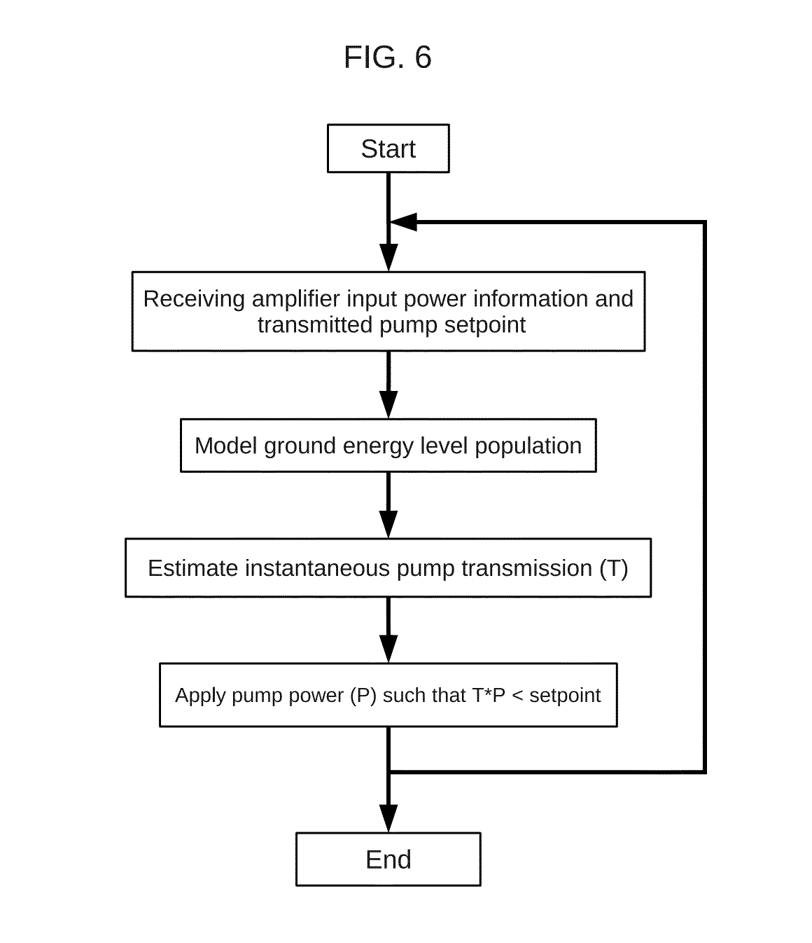

The control process is described by the flow cart in FIG. 6. After start the process runs recursively by receiving amplifier input power information e.g. by optical detection or as an electrical signal representing the optical power, in addition to this input the set point for transmitted pump power is received. The dynamic model models the ground level population based on the history and new inputs. The instantaneous pump transmission is estimated from the ground level population. Pump is applied in accordance with the instantaneous pump transmission. Then, return to the first step unless the control is turned off and ends the process.

The invention is particularly useful in optical amplifiers operating in or near the linear gain regime. This regime is characterized by the gain depending mostly on the propagation length of the signal in the gain medium, the gain medium being inverted by a strong pump. The low gain saturation in this regime allow pulses or bursts of pulses to be amplified with low distortion. To maintain the amplifier operation in this regime excess pump power is applied. The invention provides a method and apparatus to regulate the excess pump power to maintain the amplifier in the desired operation regime, but without having excess pump power levels which are technically difficult to dump in a safe way or cause an unnecessary low power efficiency of the amplifier device.

This is in contrast to prior art optical amplifier control schemes which uses a regulation of the upper laser energy level inversion to achieve a control of the output power level.

The working and utility of the invention will be more evident after the following exemplary embodiment description.

### DETAILED DESCRIPTION OF EXEMPLARY EMBODIMENT

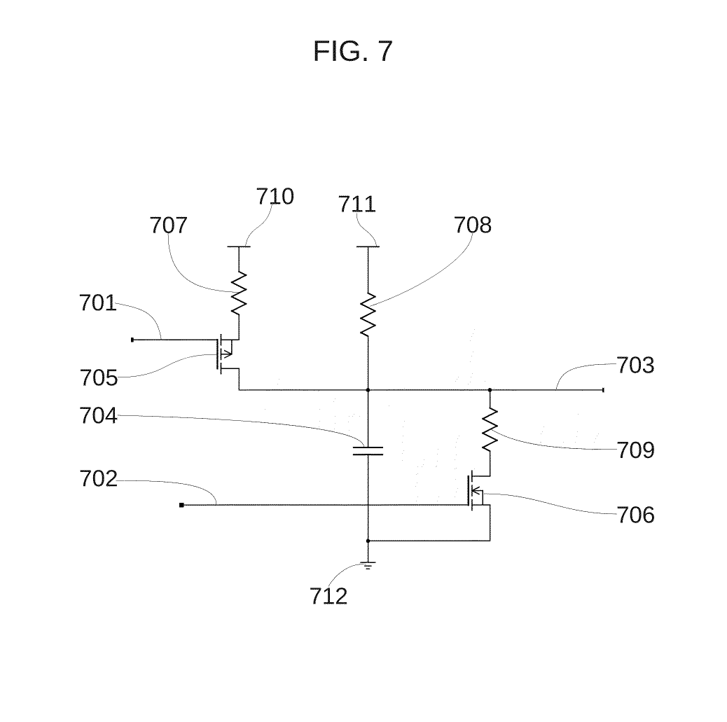

The exemplary embodiment of the invention is an analog electronics circuit where the core is the equivalent circuit as in FIG. 7 with signal current term implemented by P-type MOSFET transistor 705, receiving the input signal 701 and resistor 705 with a bias voltage 710. Spontaneous emission term by 708 and pump representing current term by N-type MOSFET 706, receiving a pump control signal 702 and resistor 709. These source and sink terms determines the voltage on capacitor 704, this voltage 703 it the model for the amplifier ground energy state population.

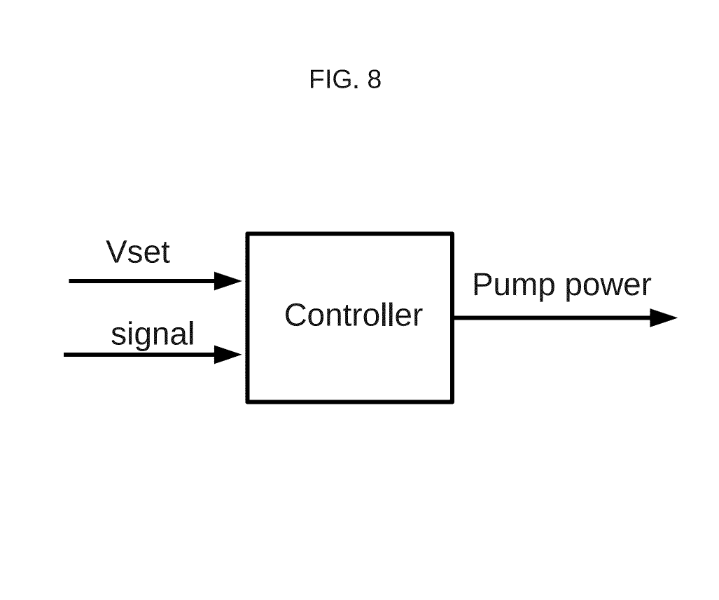

Input and output view of the controller is shown in FIG. 8. The inputs are the set point for the ground energy state inversion Vset and a signal representative of the optical amplifier optical input. The output is the optical pump power.

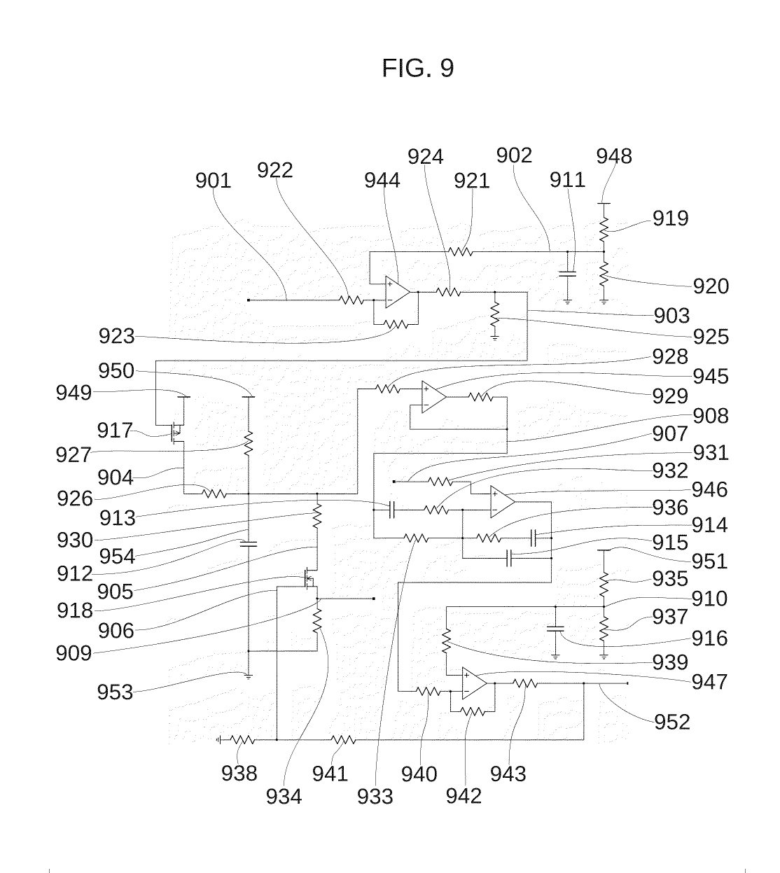

FIG. 9 is the full circuit diagram of an exemplary circuit embodiment of the controller of the invention. Reference designators 911-947 refer to circuit elements; resistors, capacitors, transistors and operational amplifiers. Electronic nets, i.e. electronic galvanic connections such as a copper wire or track assuring that the net has one potential relative to GND 953. 901-910 and 948-954 are nets.

The input setpoint (Vset) is supplied to the controller net 907 as a voltage signal. The signal input is represented by the net voltage 701. The ground state inversion and thereby the pump absorption is represented by the voltage at net 954 across the capacitor 912.

The three model terms for spontaneous emission, signal stimulated emission and pump excitation are represented by circuit elements. The spontaneous emission is represented by 927, the lower the population in the ground state the smaller voltage at 954, and the larger the current representing spontaneous emission.

Signal stimulated emission is represented by 917 and 926. The transistor 917 is driven by the signal at net 903 which is a conditioned, inverted and level shifted version of the input signal at net 901, such that the voltage at 954 increases more the larger the signal. The operational amplifier 944 performs the inversion and is coupled with resistors 922 and 923 for gain adjustment and offset is provided by the voltage divider between the resistors 919 and 920 from the voltage supply 948. Capacitor 911 and resistor 921 serves for stabilization of the offset voltage. Pump excitation is applied to reduce ground state population and accordingly represented in the circuit as a discharge path reducing the voltage at net 954 by bringing the transistor 918 in conduction. The transistor 918 is controlled by the voltage at the net 906 which is a feedback signal from sensing of the voltage at net 954 by the operational amplifier 945 which produces a buffered voltage copy at net 908 of voltage at net 954. The buffered voltage at net 908 is the input to the conventional single operational amplifier proportional integral and differential (PID) controller, composed by the elements 946, 913, 932, 933, 936, 914 and 915 comparing the set point voltage at net 907 with that at 908, to produce a deviation or error signal for the control feedback. The output of the operational amplifier 946 is conditioned by another operational amplifier 947. The supply voltage 951 drives the voltage divider between 935 and 937, filtered by the capacitor 916 produces the offset voltage at 910 coupled to the operational amplifier 947 via a resistor 939 for improved stability. This produces the conditioned signal at net 906 via resistors 943 and 941 to drive the gate of transistor 918 producing a current through 930, 918 and 934 which forces the voltage at net 954 to the set point value at net 907. This current is sensed by the resistor 934 to produce the output which is used as regulating signal for the laser diode driver. 909. The circuit has a common ground for zero voltage reference indicated with the symbol 953. The supplies 949 and 950 may be equal and must be at a higher potential than the setpoint at net 907.

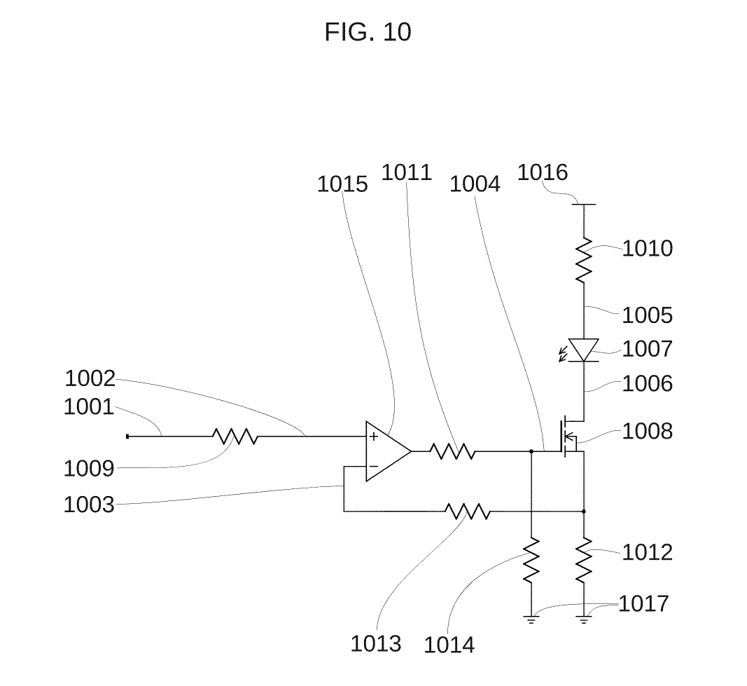

Referring to FIG. 10 showing the optical pump laser diode drive arrangement. The arrangement is a constant current sink regulating the current through the optical pump laser diode 1007 in proportion to the ratio between resistor 934 and resistor 1012 to the current through resistor 934 in the equivalent circuit model of FIG. 9. The pump laser diode 1027 is forward biased by the supply voltage 1016, connected through a resistor 1010 for setting the maximum current to the laser diode anode net 1005. The Laser diode cathode, net 1006 is connected to a power transistor 1008. The transistor sinks a current which will equalize the positive operational amplifier input net 1002 to the negative input net 1003. The negative input is the voltage drop across the resistor 1012 and the positive input is the setpoint arriving from the controller via net 1001. The resistors 1014, 1013 and 1009 are providing filtering.

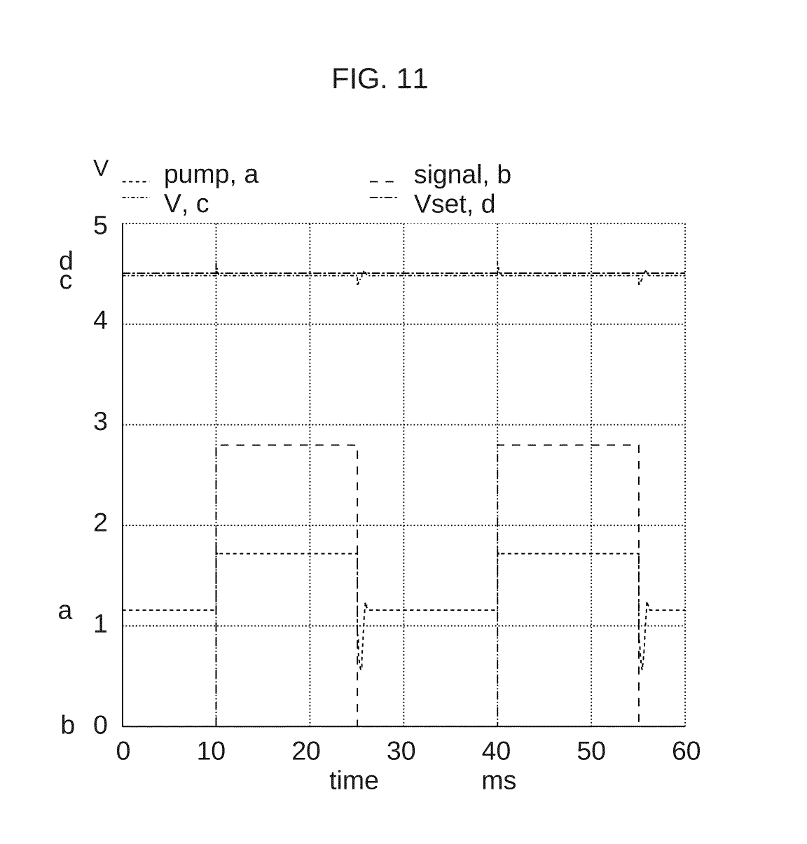

Results from numerical simulation of the circuit operation are shown in the figures FIGS. 11 to 13.

The graph in FIG. 11 show four trances, the set point voltage Vset is constant 4.5V, the input signal “signal” is a square pule with 15 ms at the high 1.7V level. The control circuit regulates the “pump” to compensate deexcitation from spontaneous emission, when the signal is off and the sum of spontaneous emission and signal stimulated emission given by the signal level when the signal is on. In this way V is maintained at the setpoint near 4.5V.

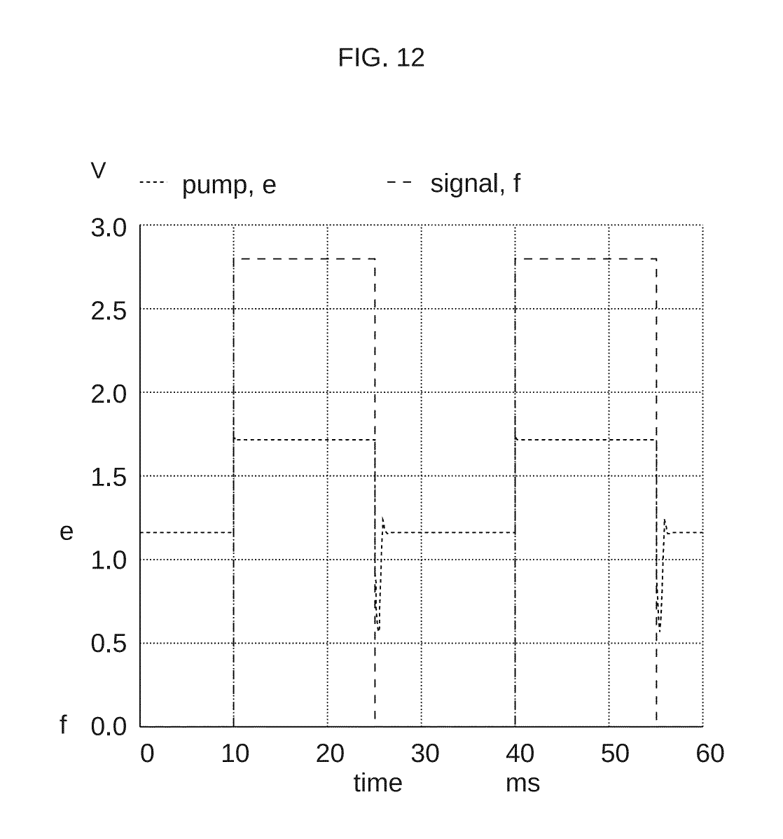

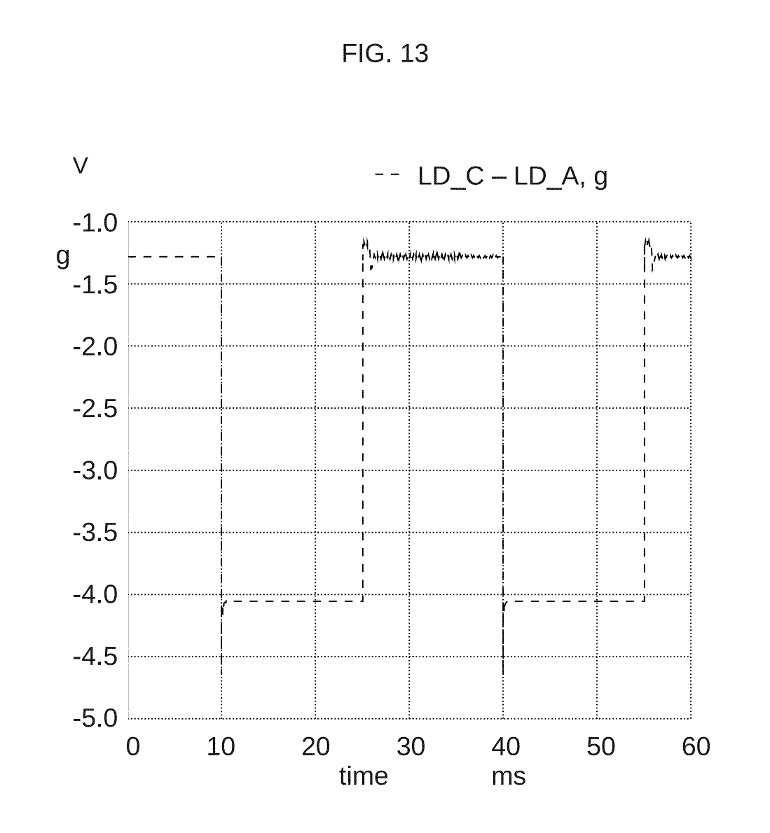

The graph in FIG. 12 with expanded scale show two traces, the signal square pulse of 15 ms high and 15 ms low and the pump respond by increasing when the signal is high. In FIG. 13 graph showing the voltage drop across the pump laser diode, diode D2 in FIG. 10, the drop in voltage is caused by the forward current producing optical pump power output.

The utility of the circuit is its ability to regulate the pump power such that pumps only emit what the gain medium in the amplifier can absorb. Without the control one could leave the pumps always on, in which case the ground state inversion and the pump absorption would be low whenever the signal is off or takes a low value. The disadvantage would be that a large fraction of the pump power is transmitted and dissipated as heat in the pump dump. Furthermore the excessive pumping would lead to the optical amplifier output overshooting when the signal is first turned on.

As an alternative, to having pumps always on the pumps could be turned on when the signal is applied to the amplifier, say in proportion to the input signal. This would be a safe approach as it will not lead to excess pumping. Due to a finite pump rate the leading portion of the signal would not be amplified and the output would undershoot. The disclosed invention provides an optimal control allowing the optical amplifier amplify the leading portion of the signal the same as the steady state input without excess dissipated pump power.

It is obvious to anyone skilled in laser physics that the invention described in the context of a quasi 2 level laser system can be applied to a laser system of any number of excited energy levels as long as the excitation is dominated by pump absorption and the deexcitation by dominated by signal stimulated emission. The equations above are deduced for a copropagating signal and pump, and leads to a point state variable. It is obvious that counter pumping would lead to the same result.

The equivalent circuit model receives information about the input signal, e.g. by measurement using a photo diode and a trans impedance amplifier. The current term I_{S}^{Netto} in equation (10) is representative of the amplified signal. It is obvious that for a cascade with any number of optical amplifiers in series, the input signal power to amplifiers following the first in the cascade can be either measured as the optical power or sensed from the model of the preceding amplifier.

If the amplifier is part of a laser system, such that the input power is known from the operation parameters set for the laser oscillator, then the amplifier input power can be determined from the operation parameters, replacing the optical input power measurement.

The exemplary embodiment used analog electronics circuit elements, it is obvious that analog to digital signal conversion and replacement of any or all of the analog circuit elements with digital electronics is an equivalent alternative. The exemplary embodiment uses proportional, integral and differential control feedback, it is obvious that proportional only or on-off control can be used based on the same error signal, the difference between setpoint and modeled s(t).

What is claimed is:

1. An optical amplifier system comprising:
a gain medium surrounded by a pump radiation guide;
a pump radiation source coupled to the pump guide;
a control system acting on the pump radiation power coupled to the pump radiation guide, said control system configured to receive input signal power information, pump rate information and containing;
an equivalent circuit model tracking the pump absorption;
a decision circuit comparing the model pump absorption with a setpoint and producing a deviation signal used to control the pump radiation power to limit the coupled pump radiation when model pump absorption is low compared to the set-point.

2. A system of claim 1, in which the equivalent circuit model comprises:
a capacitor, the voltage across which represents a state variable for the amplifier ground level inversion;
a charge paths for the capacitor representing spontaneous emission by a fixed resistance connecting to a supply rail;
a charge path representing optical input signal power by a variable restive element connecting to a supply rail and varying in responses to varying input optical power;
a discharge path across said capacitor, this path representing pumping and being regulated by a feedback circuit comparing the capacitor voltage with a setpoint, this path being configured for its passing current to be measured;
and the pump radiation source contains:
one or more pump laser diodes;
a current driver connected to said laser diodes and driving a current through them in proportion to the current measured in the discharge path of the circuit model.

3. Fiber laser system comprising:
a laser oscillator and
a power amplifier receiving as its input the output of the laser oscillator, the laser oscillator operation conditions information transmitted to the pump controller of the power amplifier, said controller using this information in
a model to estimate relationship between launched and leaked pump power to regulate the launched pump power maintaining the leaked pump power below or at a setpoint, the controller containing a real time model for the dynamics of the population in the ground energy level of the laser medium active ions.

4. A method for controlling excess pumping of a laser medium, the method having the recursive steps of:
receiving amplifier input power signal;
receiving excess pump power setpoint;
model a state variable dependent on input power signal and a model pump, the state variable being representative of instantaneous optical pump power absorption;
computing an error signal from the deviation between the setpoint and the state variable;
regulating model and optical pump coupled to the laser medium synchronously and in proportion in the direction minimizing the error signal.
